(19) United States
(12) Patent Application Publication
(10) Pub. No.: US 2004/0088917 A1
(43) Pub. Date: May 13, 2004

(54) Irrigation system

(76) Inventor: Robert J. Chambers, Montrose, CA (US)

Correspondence Address: INGRASSIA FISHER & LORENZ, P.C., 7150 E. CAMELBACK, STE. 325, SCOTTSDALE, AZ, 85251, US

(21) Appl. No.: 10/692,526

(22) Filed: Oct. 24, 2003

Related U.S. Application Data
(60) Provisional application No. 60/421,410, filed on Oct. 24, 2002.

(51) Int. Cl. A01G 29/00

(52) U.S. Cl. 47/58.1 SC; 47/48.5

(57) ABSTRACT

An irrigation system is provided in accordance with the present invention. The irrigation system is configured to distribute an irrigation fluid into a soil. The irrigation system comprising a first layer having a first aperture and a second layer that is secured to the first layer to form a fluid cavity for receiving the irrigation fluid. The second layer has a second aperture that is aligned with the first aperture to form a soil aperture, which is configured to pass at least a portion of the soil. The irrigation system also comprises a fluid distributor formed between the first layer and the second layer. The fluid distributor is configured to emit the irrigation fluid contained in the fluid cavity into the soil aperture such that that the irrigation fluid is distributed into the soil.

### CROSS-REFERENCE TO RELATED APPLICATIONS

This application claims the benefit of U.S. Provisional Application No. 60/421,410, filed Oct. 24, 2002, which is incorporated herein by reference in its entirety.

### FIELD OF THE INVENTION

The present invention generally relates to irrigation, and more particularly relates to an irrigation system for distributing an irrigation fluid into a soil.

### BACKGROUND OF THE INVENTION

Numerous irrigation systems current exist for fluid distribution. For example, sprinkler systems, seep hose systems, and drip systems are well known irrigation systems. However, these irrigation systems are subject to a variety of deficiencies that can result in high production costs, excessive installation and installation activities. Furthermore, these irrigation systems and other currently available irrigation systems, often provide less than desirable distribution of fluid in the soil that is intended for irrigation.

Sprinkler systems typically comprise a series of irrigation pipes and/or hoses which are connected to one or more sprinkler heads. An irrigation fluid is subsequently pumped through the piping and/or hoses and the sprinkler head distributes the fluid in a desired area. While sprinkler systems generally provide adequate irrigation, there are undesirable characteristics associated with this irrigation system.

For example, sprinkler heads are typically exposed and are susceptible to damage from landscaping devices such as lawn mowers, tractors, plows, and the like. Additionally, exposure of sprinkler heads to environmental elements (e.g., solar rays, rain, snow and ice) tends to increase the rate of degradation of the materials forming the exposed sprinkler heads. Furthermore, as the sprinklers typically comprise numerous mechanical components, a substantial amount of maintenance is needed to provide proper operation on a continual basis. However, these problems and other problems associated with sprinkler systems also exist for other irrigation systems.

Seeping hose systems suffer from some of the same problems as the problems encountered with sprinkler systems, and also suffer from some unique deficiencies. A seeping hose system generally comprises permeable tubing which is connected to an irrigation fluid source. The permeable tubing is placed on the surface and/or under the surface of the area that is intended for irrigation. As the irrigation fluid flows through the tubing, the permeable nature of the tubing allows the fluid to “seep” through the walls of the tubing, thus irrigating the area adjacent to the tubing. However, it is typically difficult to ascertain whether a seeping hose system is sufficiently irrigating the desired area and, similarly, to determine whether the irrigation fluid is evenly distributed about the desired irrigation area. Furthermore, the tubing generally does not perform well for areas having surfaces with a slope, and the complexity of such a system inherently creates significant installation costs and time.

In view of the foregoing, it should be appreciated that it is desirable to provide an irrigation system that addresses the deficiencies of prior irrigation systems as previously discussed in this background of the invention, and also addresses other deficiencies not explicitly or implicitly described in this background of the invention. Furthermore, other desirable features and characteristics of the present invention will become apparent from the subsequent detailed description of the invention and the appended claims, taken in conjunction with the accompanying drawings.

### BRIEF SUMMARY OF THE INVENTION

An irrigation system is provided that is configured to distribute an irrigation fluid into a soil. The irrigation system comprising a first layer having a first aperture and a second layer that is secured to the first layer to form a fluid cavity for receiving the irrigation fluid. The second layer has a second aperture that is aligned with the first aperture to form a soil aperture, which is configured to pass at least a portion of the soil. The irrigation system also comprises a fluid distributor formed between the first layer and the second layer. The fluid distributor is configured to emit the irrigation fluid contained in the fluid cavity into the soil aperture such that the irrigation fluid is distributed into the soil.

### BRIEF DESCRIPTION OF THE DRAWINGS

The present invention will hereinafter be described in conjunction with the following drawing figures, wherein like numerals denote like elements, and

FIG. 1 is an irrigation system for distributing an irrigation fluid into a soil in accordance with the present invention;

FIG. 2 is an expanded view of the irrigation system of FIG. 1;

FIG. 3 is a cross-sectional view of FIG. 1 taken along lines 3-3;

FIG. 4 is an enlarged view of a section of FIG. 1 with one of the layers having seep holes in accordance with the present invention;

FIG. 5 is an enlarged view of a soil aperture of FIG. 1 having a fluid distributor in accordance an embodiment of present invention;

FIG. 6 is an enlarged view of a soil aperture of FIG. 1 having a fluid distributor in accordance with another embodiment of the present invention;

FIG. 7 is an enlarged view of a soil aperture of FIG. 1 having a fluid distributor in accordance with yet another embodiment of the present invention; and

FIG. 8 is a cross-sectional view of FIG. 7 taken along lines 8-8.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

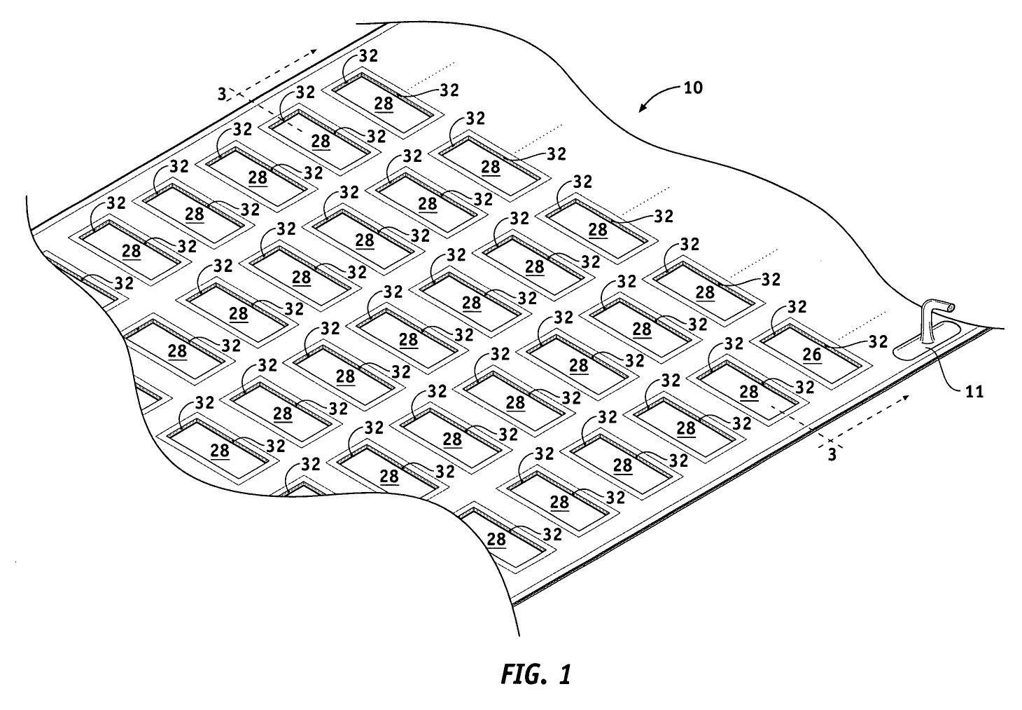

Referring to FIG. 1, an irrigation system 10 is illustrated in accordance with the present invention. The irrigation system 10 is configured to distribute an irrigation fluid (not shown) into a soil (not shown) as received through a connector device 11, which can have any number of configurations, such as the connector device 14 described in U.S. Pat. No. 6,293,477, issued on Sep. 25, 2001 to Robert J. Chambers and titled “Method and Apparatus for Distribution and/or Collection of Fluids.” U.S. Pat. No. 6,293,477, which shall be referred to herein as the “Chambers Reference,” is hereby incorporated in its entirety by reference. The irrigation system 10 can be configured to distribute any number of irrigation fluids (i.e., an irrigation liquid and/or an irrigation gas), such as water. In addition, the irrigation system 10 can be configured to distribute the irrigation fluid into any number of natural or synthetic soils, or a combination of soils.

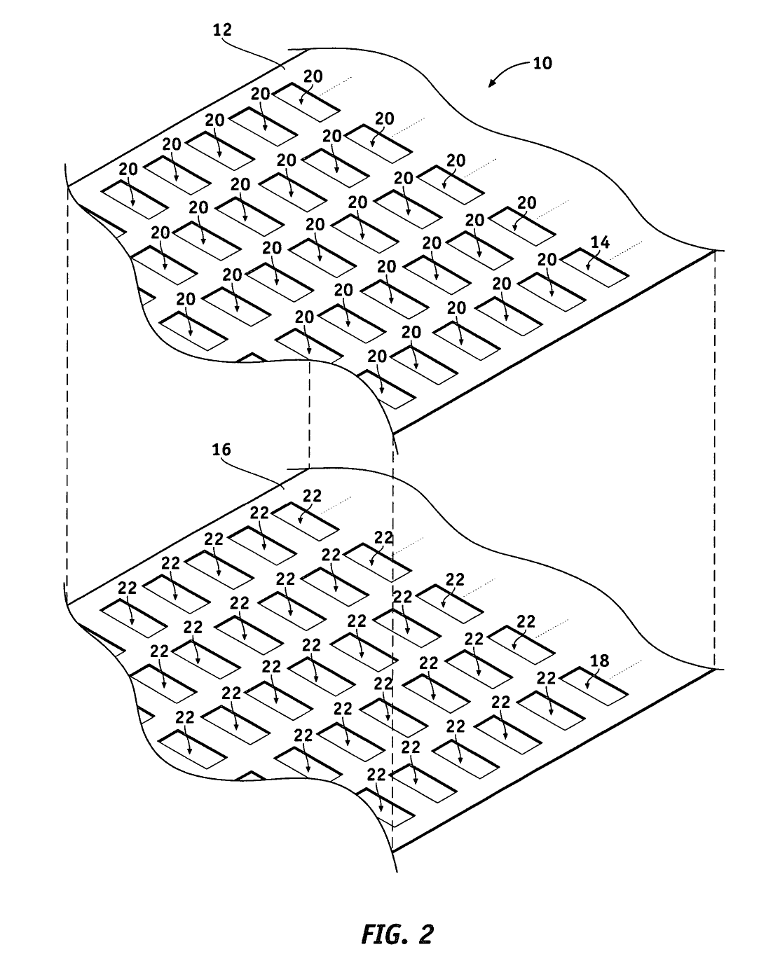

Referring to FIG. 2, the irrigation system 10 comprises a first layer 12 having a first aperture 14 and a second layer 16 having a second aperture 18. Preferably, the first layer 12 has apertures 20 in addition to the first aperture 14 (i.e., the first layer 12 has multiple apertures) and the second layer has apertures 22 in addition to the second aperture 18 (i.e., the second layer 16 has multiple apertures). Furthermore, as described in the Chambers Reference, additional layers can be utilized in addition to the first layer 12 and the second layer 16 (e.g., a third layer, fourth layer, . . . , Nth layer, where N is greater than two (2)). The layers in addition to the first layer 12 and the second layer 16 can be configured to provide a variety of functions or combination of functions, and also be formed of the same material or materials of the first layer 12 and the second layer 16 or a different material or materials than the first layer 12 or the second layer 16. For example, the additional sheet or sheets can be configured to provide additional cavities, or a non-root-invasive fibrous sheet can be configured to inhibit the growth of roots in specific areas of the irrigation system.

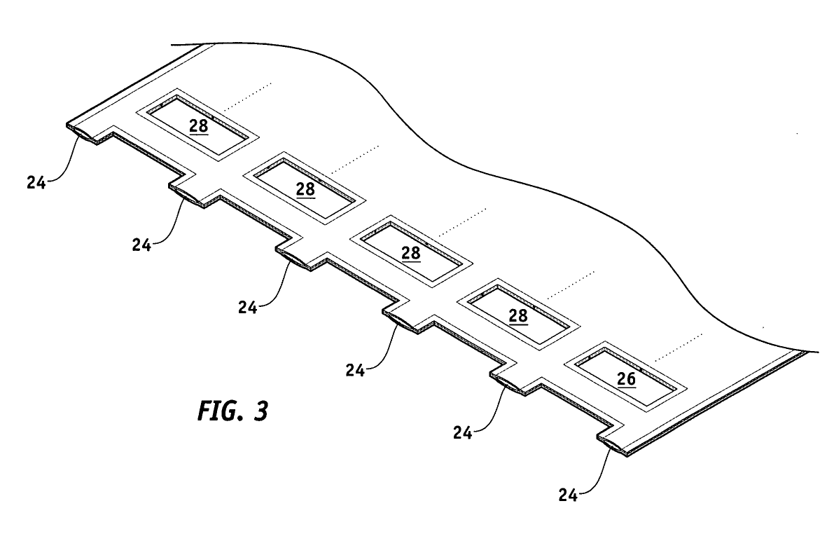

The first layer 12 and the second layer 16 are configured to form a fluid cavity 24 as shown in FIG. 3 for receiving the irrigation fluid, and the first layer 12 and the second layer 16 are preferably configured to be at least partially covered by the soil. In addition, the first layer 12 and the second layer 16 are configured to form a first soil aperture 26 as shown in FIG. 1, which is configured to pass at least a portion of an object, such as the soil and/or a plant root. The first soil aperture 24 as shown in FIG. 1 is formed with at least a partial alignment of the first aperture 14 and the second aperture 18, and preferably formed with a substantial alignment of the first aperture 14 and the second aperture 18. Furthermore, the first layer 12 and the second layer 16 are also preferably configured to form soil apertures 28 in addition to the first soil aperture 26 as shown in FIG. 1, which are also preferably configured to pass at least a portion of the soil. The first soil aperture 26, and any of the other soil apertures 28, can be any number of sizes, any number of geometrical shapes, or arrangements of these sizes and geometrical shapes, or a combination of different sizes, geometrical shapes, and/or arrangements. For example, the soil apertures can be rectangular, circular, triangular, octagonal, or hexagonal, or a combination thereof.

The fluid cavity 24, the first soil aperture 26, and any of the other soil apertures 28 as shown in FIG. 3, can be formed from the first layer 12 and the second layer 16 using any number of techniques. For example, the first layer 12 can be a first sheet of material and the second layer 16 can a second sheet of material that is secured to the first sheet of material. Preferably, the first sheet of material is secured to the second sheet of materials at or near the outer edges of each sheet and also secured at or near the edges of the first aperture 14 and second aperture 18, and at or near the edges of any other apertures 20 of the first layer 12 and the respective edges of the apertures 22 of the second layer 16. The first sheet and the second sheet can be secured with any number of techniques such as adhesion or a fusing/welding process using heat, ultrasonic energy and the like. (See the Chambers Reference for examples of techniques that can be used to secure the first sheet and the second sheet.) Alternatively, the first layer 12 and the second layer 16 can be provided with a single sheet of material having multiple apertures that is folded, aligned, and secured to form the fluid cavity 20, the first soil aperture 26, and any of the other soil apertures 28.

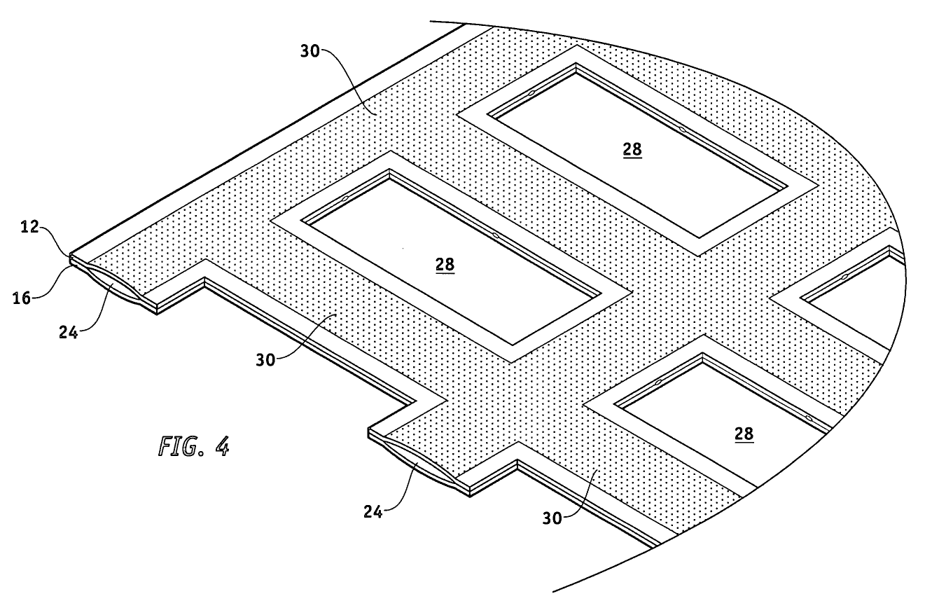

The first layer 12 and the second layer 16, which can be formed as previously described or formed of a single sheet of material, are preferably a flexible or semi-flexible material. The flexible or semi-flexible material can be any number of materials or material compositions such as polyethylene, polypropylene, nylon or the like. Furthermore, the first layer 12, the second layer 16, or the first layer 12 and the second layer 16 can be a porous or a non-porous material, or the first layer 12, the second layer 16, or the first layer 12 and the second layer 16 can have a plurality of seep holes 30 to facilitate the transfer of the irrigation fluid from the fluid cavity 24 into the soil as shown in FIG. 4. In addition, the first layer 12 and the second layer 16 can be configured such that one of the layers (12,16) is porous and one of the layers (12,16) is non-porous, or one of the layers (12,16) has one or more seep holes and one of the layers (12,16) does not have seep holes, or the first layer 12, second layer 16, and any other layer can be any combination of porous materials, non-porous materials, materials with seep holes and materials without seep holes. The porous materials and/or seep holes of the first layer 12 and/or second layers are configured to distribute the irrigation fluid contained within the fluid cavity into the soil.

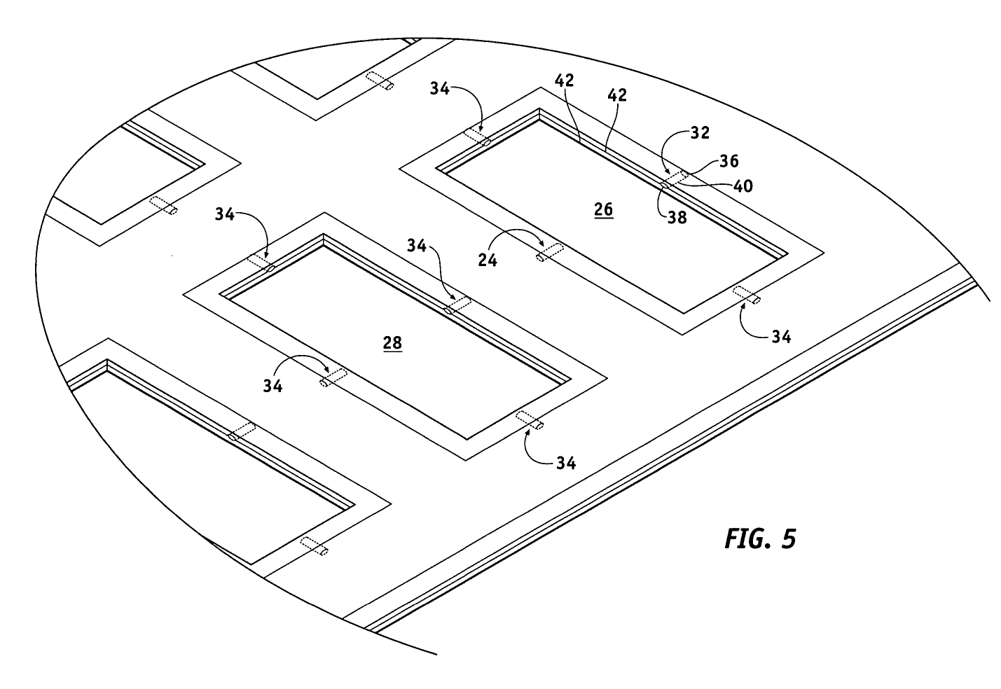

In addition to the porous materials and/or seep holes in the first layer 12 and/or second layer 16, the irrigation system 10 preferably comprises a fluid distributor 32 as shown in FIG. 1. Referring to FIG. 5, the fluid distributor 32 is formed between the fluid cavity and the first soil aperture 26, or other soil apertures 28 and configured to distribute the irrigation fluid contained in the fluid cavity at the first soil aperture 26 or other soil apertures 28. Alternatively, the fluid distributor 32, and any additional fluid distributors 34, can be configured to be the sole or primary distributor of irrigation fluid into the soil (i.e., the fluid distributor 32 or fluid distributors 34 can be utilized without porous materials and/or seep holes in the first layer 12 and/or second layer16).

The first soil aperture 26 and the other soil apertures 28 can have a single fluid distributor 32 or multiple fluid distributors 32. Alternatively, a first subset of the first soil aperture 26 and the soil apertures 28 can have one or more fluid distributors 32. In addition, the irrigation system 10 can be configured such that a second subset of the first soil apertures 26 and the soil apertures 28 does not have a fluid distributor.

Referring to FIG. 5, an enlarged view of the first soil aperture 26 is illustrated with the fluid distributor 32 in accordance with the present invention. The fluid distributor 32 comprises a first aperture 36 at or within the fluid cavity 24 and a second aperture 38 at or within the first soil aperture 26, which is connected to the first aperture 36 with a passage 40. The passage 40 extends from the first aperture 36 and through a secured edge 42 of the first layer and the second layer, and is configured to transfer irrigation fluid from the fluid cavity into the first aperture 26, or other apertures 28 having a fluid distributor 32. As previously discussed in this detailed description of the invention, the secured edge 42 can be formed when the fluid cavity, the first soil aperture 26, and any of the other soil apertures 28 are formed from the first layer 12 and the second layer, or the secured edge 42 can be formed before or after formation of the fluid cavity 20, the first soil aperture 26, and any other soil apertures 28 using any number of techniques as previously described in this detailed description of the invention. The passage 40 can have any number of shapes and sizes, and also take any number of paths to connect the first aperture 36 and the second aperture 38.

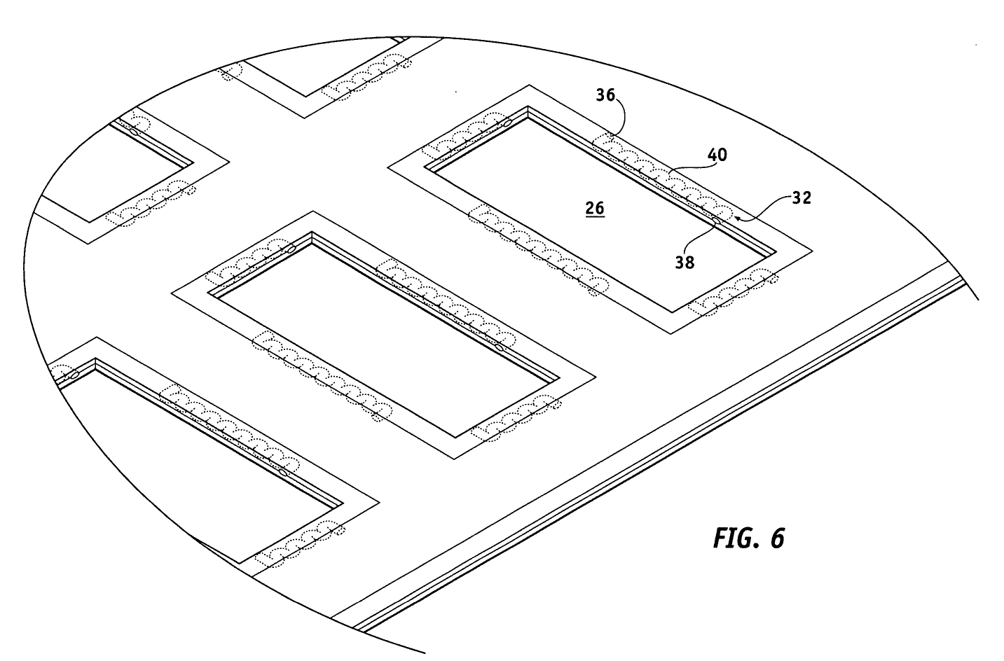

Referring to FIG. 6, an embodiment of the present invention is shown in which the passage 40 connecting the first aperture 36 and the second aperture 38 is a torturous path. The passage 40 configured with a tortuous path can decrease the flow rate of the irrigation fluid from the fluid cavity into the soil aperture. This tortuous path configuration of the passage 40 can assist with difficulties associated with irrigation systems, such as uneven fluid flow in a modulating elevation terrain. Furthermore, the passage 40 configured with a tortuous path configuration can have any number of lengths and/or contours, or combination of different contours.

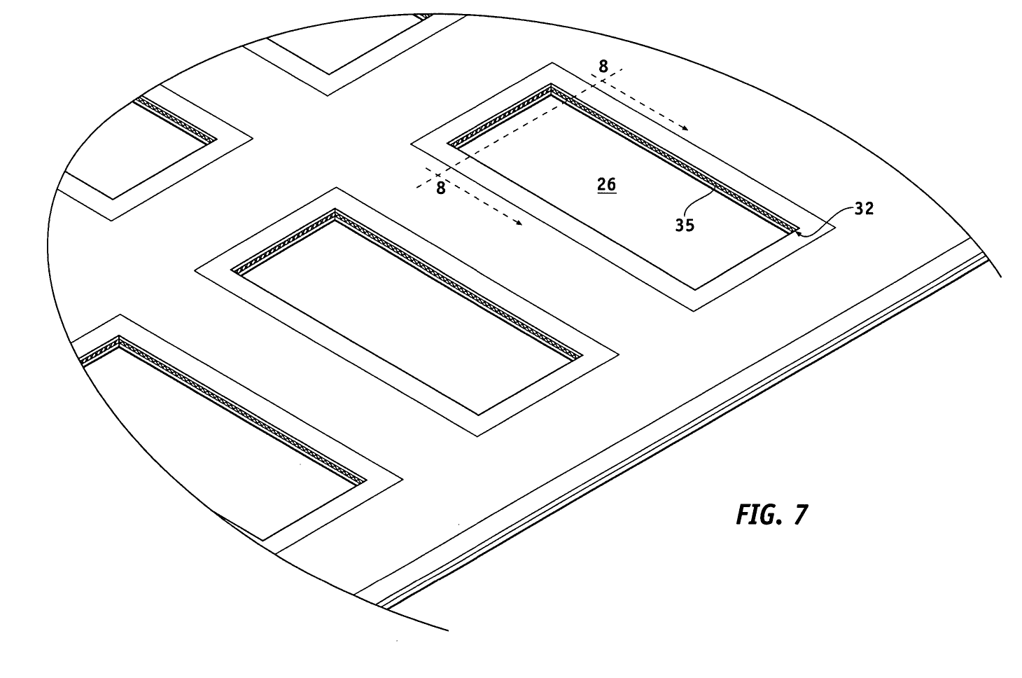

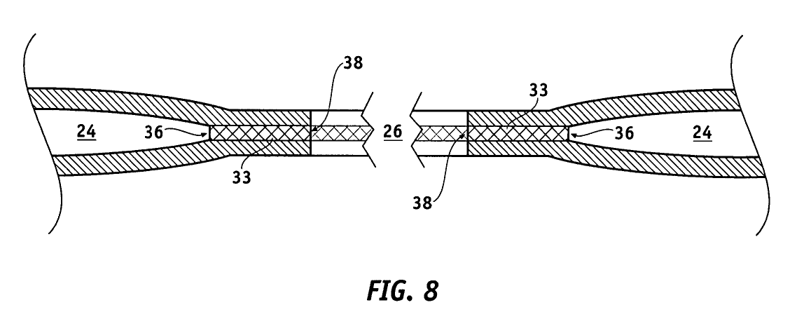

Referring to FIG. 7, another embodiment of the present invention is shown for the fluid distributor 32 in accordance with the present invention. The passage 40 of the fluid distributor comprises a porous, semi-porous, and/or fibrous material 33 formed between the first layer and the second layer. The porous, semi-porous, and/or fibrous material 33 can extend along a portion of soil aperture or the porous, semi-porous, and/or fibrous material 33 can extend along substantially all or the entire soil aperture 26. As can be seen in FIG. 8, the fluid distributor configured with a porous, semi-porous, and or fibrous material 33 formed between the first layer 12 and second layer 16 provides the ability of the of the irrigation fluid contained in the fluid cavity 24 to travel from the first aperture 36 of the fluid distributor 36 to the second aperture 38 of the fluid distributor in a controlled manner to distribute the irrigation fluid into the first soil aperture 26.

While an exemplary embodiment(s) has been presented in the foregoing detailed description of the invention, it should be appreciated that a vast number of variations exist. It should also be appreciated that these exemplary embodiments are only examples, and are not intended to limit the scope, applicability, or configuration of the invention in any way. Rather, the foregoing detailed description will provide those skilled in the art with a convenient road map for implementing a preferred embodiment of the invention. It being understood that various changes may be made in the function and arrangement of elements described in an exemplary preferred embodiment without departing from the spirit and scope of the invention as set forth in the appended claims.

What is claimed is:

1. An irrigation system that is configured to distribute an irrigation fluid into a soil, comprising:
a first layer having a first aperture;
a second layer secured to said first layer to form a fluid cavity for receiving the irrigation fluid, said second layer having a second aperture that is at least partially aligned with said first aperture to form a soil aperture that is configured to pass at least a portion of the soil; and
a fluid distributor formed between said first layer and said second layer, said fluid distributor configured to emit the irrigation fluid contained in said fluid cavity into the soil aperture such that that the irrigation fluid is distributed into the soil.

2. The irrigation system of claim 1, said fluid distributor comprising:
a first aperture configured to receive the irrigation fluid from said fluid cavity;
a second aperture configured to distribute the irrigation fluid into said soil aperture; and
a passage connecting said first aperture and said second aperture.

3. The irrigation system of claim 2, wherein said passage extends through a secured edge of said first layer and said second layer.

4. The irrigation system of claim 2, wherein said passage is a torturous path.

5. The irrigation system of claim 2, wherein said passage comprises a porous material.

6. The irrigation system of claim 1, wherein said soil aperture has a rectangular shape.

7. The irrigation system of claim 1, wherein said second layer is adhesively secured to said first layer to form said fluid cavity for receiving the irrigation fluid.

8. The irrigation system of claim 1, wherein said first layer and said second layer are provided with multiple sheets of material.

9. The irrigation system of claim 1, wherein said first layer and said second layer are provided with a single sheet of material.

10. The irrigation system of claim 1, wherein said first layer is a sheet of semi-flexible material.

11. The irrigation system of claim 1, wherein said first layer is a sheet of porous material.

12. The irrigation system of claim 1, wherein said first layer has at least one seep hole.

13. The irrigation system of claim 1, wherein said first layer has a plurality of seep holes.

14. An irrigation system that is configured to distribute an irrigation fluid into a soil, comprising:
a first layer having a first plurality of apertures;
a second layer secured to said first layer to form a fluid cavity for receiving the irrigation fluid, said second layer having a second plurality of apertures that are at least partially aligned with said first plurality of apertures to form a plurality of soil apertures that are configured to pass at least a portion of the soil; and
a plurality of fluid distributors formed between said first layer and said second layer, said plurality of fluid distributors configured to emit the irrigation contained in said fluid cavity into said plurality of soil apertures such that the irrigation fluid is distributed into the soil.

15. The irrigation system of claim 14, at least one of said plurality of fluid distributors comprising:
a first aperture configured to receive the irrigation fluid from said fluid cavity;
a second aperture configured to distribute the irrigation fluid into at least one of said plurality of soil apertures; and
a passage connecting said first aperture and said second aperture.

16. The irrigation system of claim 15, wherein said passage extends through a secured edge of said first layer and said second layer.

17. The irrigation system of claim 15, wherein said passage is a torturous path.

18. The irrigation system of claim 15, wherein said passage comprises a porous material.

19. The irrigation system of claim 14, wherein at least one of said plurality of soil aperture has a rectangular shape.

20. The irrigation system of claim 14, wherein said second layer is adhesively secured to said first layer to form said fluid cavity for receiving the irrigation fluid.

21. The irrigation system of claim 14, wherein said first layer and said second layer are provided with multiple sheets of material.

22. The irrigation system of claim 14, wherein said first layer and said second layer are provided with a single sheet of material.

23. The irrigation system of claim 14, wherein said first layer is a sheet of semi-flexible material.

24. The irrigation system of claim 14, wherein said first layer is a sheet of porous material.

25. The irrigation system of claim 14, wherein said first layer has at least one seep hole.

26. The irrigation system of claim 14, wherein said first layer has a plurality of seep holes.
